(19) United States
(12) Patent Application Publication
(10) Pub. No.: US 2010/0093953 A1
(43) Pub. Date: Apr. 15, 2010

(54) POLYETHYLENE, PROCESS AND CATALYST COMPOSITION FOR THE PREPARATION THEREOF

(75) Inventors: Lars Kölling, Mannheim (DE); Shahram Mihan, Bad Soden (DE)

Correspondence Address: LyondellBasell Industries, 3801 WEST CHESTER PIKE, NEWTOWN SQUARE, PA, 19073, US

(73) Assignee: Basell Polyolefine GmbH, Wesseling (DE)

(21) Appl. No.: 12/451,106

(22) PCT Filed: Apr. 17, 2008
(86) PCT No.: PCT/EP2008/054654

§ 371 Date: Dec. 4, 2009

Related U.S. Application Data
(60) Provisional application No. 60/927,582, filed on May 4, 2007.

(51) Int. Cl. C08F 4/24; C08F 210/02; B01J 31/12; B29C 45/00; B29C 43/00; B29C 47/00

(52) U.S. Cl. 526/96; 526/352; 502/154; 264/328.1; 264/500; 264/176.1

(57) ABSTRACT

A multimodal polyethylene having an inverse comonomer distribution, as well as a process carried out in a single reactor in the presence of a mixed catalyst composition comprising two different polymerization catalysts, are described. The multimodal polyethylene has a density of 0 915-0 970 g/cm³, a weight average molar mass Mw of 100 000-900 000 g/mol, and a polydispersity M_{w}/Mₙ, of at least 15. The at least one homopolymer has a density of 0 950-0 975 g/cm³, a weight average molar mass M_{w} of 10 000-90 000 g/mol and a polydispersity M_{w}/Mₙ, higher than 3 and lower than 10, and the at least one copolymer has a polydispersity M_{w}/Mₙ between 8 and 80.

### FIELD OF INVENTION

The present invention relates to a polyethylene, as well as to a process and to a catalyst composition suitable for the preparation thereof.

Multimodal polyethylenes are known, whose properties essentially depend on the nature of the ethylene polymer fractions of which they are made, as well as on the way in which the polyethylenes are prepared and, in particular, on the kind of process used to prepare the same. Among the different steps used to carry out the preparation process, a key role is played by the catalyst system selected in the (co)polymerization step(s) which is(are) carried out to obtain the polyethylene starting from the monomers, i.e. from ethylene and, optionally, one further comonomer or more further comonomers.

In the present description and in the following claims, unless otherwise indicated, the term “polymer” is used to indicate both a homopolymer, i.e. a polymer comprising repeating monomeric units derived from equal species of monomers, and a copolymer, i.e. a polymer comprising repeating monomeric units derived from at least two different species of monomers, in which case reference will be made to a binary copolymer, to a terpolymer, etc. depending on the number of different species of monomers present.

In an analogous manner, unless otherwise specified, in the present description and in the following claims, the term “polyethylene” is used to indicate both an ethylene homopolymer and a copolymer of ethylene and at least a further comonomer.

In an analogous manner, unless otherwise indicated, the term “polymerization” is used to indicate both a homopolymerization, i.e. a polymerization of repeating monomeric units derived from equal species of monomers, and a copolymerization, i.e. a polymerization of at least two different species of monomers.

In the present description and in the following claims, the term “ethylene homopolymer” is used to indicate a polymer comprising repeating ethylene monomeric units, possible comonomers of different species being present in a limited amount, in any case such that the melting temperature Tₘ of the polymer is equal to or greater than 125° C., wherein the melting temperature Tₘ is the temperature at the maximum of the melting peak as better described in the following. Tₘ is measured according to ISO 11357-3 by a first heating at a heating rate of 20° C./min until a temperature of 200° C. is reached, a dynamic crystallization at a cooling rate of 20° C./min until a temperature of −10° C. is reached, ad a second heating at a heating rate of 20° C./min until a temperature of 200° C. is reached. The melting temperature Tₘ (maximum of the melting peak of the second heating) is therefore the temperature at which the curve of the enthalpy vs. temperature of the second heating has a maximum.

In the present description and in the following claims, the term “copolymer of ethylene” is used to indicate a polymer comprising repeating ethylene monomeric units and at least one further comonomer of different species, said at least one comonomer of different species being present in an amount higher than a predetermined value, in any case such that the melting temperature Tₘ of the polymer is lower than 125° C.

Multimodal polyethylenes exhibit reduced melt flow perturbations and are preferred to monomodal polyethylenes because of improved properties for applications such as blow molding and/or films having a predetermined mechanical strength. Multimodal polyethylenes generally have a molecular mass distribution curve having more than one molecular mass peak due to the presence of a plurality of polymer fractions having distinct molecular masses. Monomodal polyethylenes have a monomodal molecular mass distribution curve, i.e. a curve having a single peak due to the presence of a single polymer fraction having a given molecular mass. Thanks to a broader molecular mass distribution, multimodal polyethylenes can be processed more easily with respect to monomodal polyethylenes.

### PRIOR ART

Various alternative methods are known to produce multimodal polyethylene, including post reactor or melt blending, use of multistage reactors, as well as catalysis in a single reactor by using a catalyst able to produce such a multimodal polyethylene. The methods influence the properties of the polyethylene in that the properties of a multimodal polyethylene depend not only on the properties of the single polymer fractions thereof, but also by the quality of mixing of these fractions. A poor mixing quality results, inter alia, in a low stress cracking resistance and adversely affects the creep behaviour of articles made of such polyethylenes.

As to the melt blending technique in an extruder, this is an expensive, cumbersome, and time consuming technique.

In processes based on multistage reactors, generally at least two reactors operating in series, each reactor operates at significantly different hydrogen concentrations in order to obtain respective polyethylene fractions having distinct molecular weights.

In the present description and in the following claims, the expression “molecular weight”, except where otherwise indicated, is used to indicate the weight average molar mass M_{w}.

A disadvantage of this process, for example with reference to a process performed in two reactors arranged in series, apart from the complexity and costs resulting from the performance of a process in two reactors, is that relatively large amounts of hydrogen have to be added to produce the fraction having the relatively lower molecular weight. As a consequence, the polyethylenes obtained in this way have a low content of vinyl groups, especially in the low molecular weight fraction, generally lower than 0.3.

Furthermore, it is technically complex to prevent comonomers added in the first reactor or hydrogen (or any other molecular weight regulator) from getting into the second reactor.

Alternatively, a single reactor can be used for the preparation of multimodal polyethylene by using catalyst compositions comprising at least two different ethylene polymerization catalysts giving rise to respective distinct polyethylene fractions.

The use of catalyst compositions comprising at least two different ethylene polymerization catalysts of the Ziegler type or the metallocene type is known. So, for example, WO 95/11264 teaches to use a combination of such two catalysts producing respective polyolefins having distinct weight average molar masses, thus resulting in a polyethylene having a broad molecular mass distribution.

In this regard, it is known that a copolymer of ethylene with higher 1-olefins such as propene, 1-butene, 1-pentene, 1-hexene or 1-octene, known as LLDPE (linear low density polyethylene), which is formed using classical Ziegler-Natta catalysts based on titanium, is different from an LLDPE which is prepared using a metallocene. The number of side chains formed by incorporation of the comonomer and their distribution, known as the SCBD (short chain branching distribution) is in particular strongly dependent on the nature of the catalyst. The number and the distribution of the side chains, in turn, influence the crystallization behaviour of the ethylene copolymer and, as a result, the mechanical properties thereof. Although the flow properties and thus the processability of these ethylene copolymers mainly depend on their molecular mass and molecular mass distribution, however, the short chain branching distribution also plays a role in particular processing methods, e.g. in film extrusion in which the crystallization behaviour of the ethylene copolymers during cooling of the film extrudate is an important factor in determining how quickly and in what quality a film can be extruded.

Polyolefins prepared by means of transition metal complexes comprising other ligands than cyclopentadienyl ligands are also known. WO 04/074333, for example, describes 2,6-bis[1-(2,6-diisopropylphenylimino)ethyl]pyridine complexes of Yttrium, a lanthanide or an actinide metal as catalysts for polymerization of conjugated dienes. WO 98/27124 discloses 2,6-bis(imino)pyridyl complexes of iron and cobalt as catalysts for homo- or co-polymerization of ethylene. WO 99/46302 discloses a catalyst composition for polymerization of alpha-olefins comprising (a) a 2,6-bis(imino)pyridyl iron component and (b) another catalysts, i.e. a zirconocene or Ziegler catalyst. J. Am. Chem. Soc. 2005, 127, 13019-13029 describes the preparation of several bis-iminopyridinato iron catalysts and a comparison of their reactivities for polymerization of ethylene. WO 05/103096 discloses a catalyst composition comprising (a) a 2,6-Bis(imino)pyridyl iron component and (b) a further catalyst, i.e. a hafnocene catalyst.

### SUMMARY OF THE INVENTION

It is an object of the present invention that of providing a multimodal polyethylene having a balanced combination of predetermined mechanical properties and processability, particularly but not exclusively in processing methods such as in film extrusion.

It is a further object of the present invention that of providing a catalyst having a predetermined activity suitable to prepare the above-mentioned multimodal polyethylene.

It is a further object of the present invention that of providing a process for preparing the above-mentioned multimodal polyethylene.

The above-mentioned object is achieved by providing a multimodal polyethylene having an inverse comonomer distribution, which advantageously allows to attain improved mechanical properties, and predetermined values of polydispersity of the at least one first ethylene polymer fraction and, respectively, of the at least one second ethylene polymer fraction, which advantageously allows to attain improved processability. More particularly, the Applicant has found that the at least one first ethylene polymer fraction having a relatively lower molecular weight and including an ethylene homopolymer should have a relatively narrower molecular mass distribution, while the at least one second ethylene polymer fraction having a relatively higher molecular weight and including an ethylene copolymer, should have a relatively broader molecular mass distribution.

An inverse comonomer distribution is a comonomer distribution in which the comonomer is substantially incorporated only in the relatively higher molecular weight ethylene polymer fractions and is referred to in the field as inverse with respect to a comonomer distribution where the relatively lower molecular weight fractions have the relatively higher comonomer contents and vice versa as obtainable, for example, by the use of conventional non-single site catalysts for each ethylene polymer fraction such as the Ziegler-Natta catalysts, while multimodal ethylene polymers having all ethylene polymer fractions produced using single-site catalysts, for example metallocene catalysts, have a substantially uniform comonomer distribution.

The present invention provides a multimodal polyethylene comprising at least one first ethylene polymer fraction including an ethylene homopolymer having a first molecular weight, and at least one second ethylene polymer fraction including an ethylene copolymer having a second molecular weight higher than said first molecular weight, the multimodal polyethylene having a density of 0.915-0.970 g/cm³, a weight average molar mass M_{w} of 100 000-900 000 g/mol, and a polydispersity M_{w}/Mₙ of at least 15, wherein the at least one homopolymer has a density of 0.950-0.975 g/cm³, a weight average molar mass M_{w} of 10 000-90 000 g/mol, and a polydispersity M_{w}/Mₙ higher than 3 and lower than 10, and wherein the at least one copolymer has a polydispersity M_{w}/Mₙ between 8 and 80.

The density of the multimodal polyethylene is preferably 0.920-0.960 g/cm³, more preferably 0.940-0.955 g/cm³. According to an alternative preferred embodiment of the invention, the density of the multimodal polyethylene is in the range of 0.930-0.967 g/cm³.

The weight average molecular mass M_{w} of the multimodal polyethylene is preferably 150 000-800 000 g/mol, more preferably 200 000-750 000 g/mol.

Preferably, the multimodal polyethylene has a polydispersity, i.e. the ratio between the weight average molecular mass M_{w} and the number average molecular mass Mₙ, of 15-180, more preferably of 15-150, more preferably of 20-150 and, still more preferably, of 20-130.

Preferably, the homopolymer of the multimodal polyethylene has a density of 0.955-0.975 g/cm³, more preferably of 0.960-0.970 g/cm³.

Preferably, the homopolymer of the multimodal polyethylene has a weight average molecular mass M_{w} of 20 000-80 000 g/mol, more preferably of 30 000-70 000 g/mol.

The polydispersity of the homopolymer of the multimodal polyethylene is 3<M_{w}/Mₙ<10, preferably 3<M_{w}/Mₙ<8, preferably 4<M_{w}/Mₙ<8, still more preferably 4<M_{w}/Mₙ<7, especially 4.5<M_{w}/Mₙ<7.

Preferably, the copolymer of the multimodal polyethylene has a density of 0.910-0.965 g/cm³, preferably 0.920-0.960 g/cm³, more preferably 0.939-0.955 g/cm³.

Preferably, the copolymer of the multimodal polyethylene has a weight average molecular mass M_{w} of 150 000-2 000 000 g/mol, preferably 180 000-1 000 000 g/mol, more preferably 200 000-800 000 g/mol.

Preferably, the copolymer of the multimodal polyethylene has a polydispersity of 8-80, more preferably 10-50, and, still more preferably, of 12-30.

According to a preferred embodiment of the invention, the multimodal polyethylene has at least 1.5 CH₃ groups/1000 carbon atoms, preferably from 1.5 to 15 CH₃ groups/1000 carbon atoms and, still more preferably, 2.5 to 10 CH₃ groups/1000 carbon atoms.

In the present description and in the following claims, the CH₃ groups/1000 carbon atoms are determined by means of ¹³C-NMR, as described by James C. Randall, JMS-REV. Macromol. Chem. Phys., C29 (2&3), 201-317 (1989), and refer to the total content of CH₃ groups/1000 carbon atoms.

Preferably, the multimodal polyethylene has at least 0.3 vinyl groups/1000 carbon atoms, preferably at least 0.5 vinyl groups/1000 carbon atoms, preferably from 0.5 to 3 vinyl groups/1000 carbon atoms, preferably from 0.5 to 2 vinyl groups/1000 carbon atoms, preferably from 0.5 to 1.5 vinyl groups/1000 carbon atoms. According to a further preferred embodiment, the multimodal polyethylene has preferably less than 5 vinyl groups/1000 carbon atoms, preferably from 1 to 3 vinyl groups/1000 carbon atoms, preferably from 2 to 3 vinyl groups/1000 carbon atoms.

Preferably, the at least one first ethylene polymer fraction has at least 0.3 vinyl groups/1000 carbon atoms, preferably at least 0.5 vinyl groups/1000 carbon atoms, preferably from 0.5 to 5 vinyl groups/1000 carbon atoms, preferably from 0.5 to 3 vinyl groups/1000 carbon atoms, preferably from 0.5 to 2 vinyl groups/1000 carbon atoms, preferably from 0.5 to 1.5 vinyl groups/1000 carbon atoms. According to a further preferred embodiment, the at least one first ethylene polymer fraction has preferably less than 5 vinyl groups/1000 carbon atoms, preferably from 1 to 3 vinyl groups/1000 carbon atoms, preferably from 2 to 3 vinyl groups/1000 carbon atoms.

In the present description and in the following claims, the content of vinyl groups/1000 carbon atoms refers to the content of —CH═CH₂ groups and is determined by means of IR, ASTM D 6248-98.

Preferably, the multimodal polyethylene has at least 0.1 vinylidene groups/1000 carbon atoms, more preferably from 0.1 to 0.5 vinylidene groups/1000 carbon atoms and, still more preferably, from 0.1 to 0.25 vinylidene groups/1000 carbon atoms.

In the present description and in the following claims, the content of vinylidene groups/1000 carbon atoms is determined by means of IR, ASTM D 6248-98.

Vinyl groups are usually attributed to a polymer termination reaction after an ethylene insertion, while vinylidene end groups are usually formed after a polymer termination reaction after a comonomer insertion.

Depending on the application of the multimodal polyethylene, it might be preferred that vinylidene and vinyl groups are subsequently functionalized or crosslinked, the vinyl groups usually being more suitable for these subsequent reactions.

The multimodal polyethylene of the invention is therefore particularly useful in applications requiring subsequent functionalization or crosslinking, such as for example pipes or adhesives.

The ethylene copolymer of the multimodal polyethylene preferably comprises at least one alpha-olefin as comonomer. Preferred alpha-olefins are all alpha-olefins having from 3 to 12 carbon atoms, for example propene, 1-butene, 1-pentene, 1-hexene, 4-methyl-1-pentene, 1-heptene, 1-octene and 1-decene. The ethylene copolymer of the multimodal polyethylene preferably comprises at least one 1-olefin having from 4 to 8 carbon atoms, for example 1-butene, 1-pentene, 1-hexene, 4-methyl pentene or 1-octene. Particular preference is given to at least one of the alpha-olefins selected from the group consisting of 1-butene, 1-hexene and 1-octene.

The multimodal polyethylene of the invention can be for example obtained by a process carried out in a single reactor in the presence of a mixed catalyst composition comprising two different polymerization catalysts as described in the following.

Accordingly, the present invention provides a catalyst composition which is particularly suitable to prepare the multimodal polyethylene describe above.

The catalyst composition of the present invention comprises (A) at least one chromium catalyst based on chromium oxide, and (B) at least one iron catalyst of formula (I),

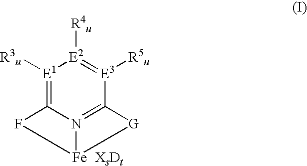

wherein the variables have the following meaning given further below jointly in relation both to structures (II) and (I) where appropriate or here, where unique to structure (I):

F and G, independently of one another, are selected from the group consisting of:

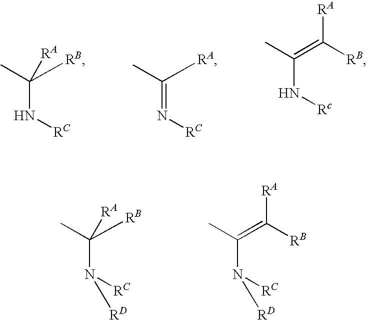

R^{A},R^{B} independently of one another denote hydrogen, C₁-C₂₀-alkyl, C₂-C₂₀-alkenyl, C₆-C₂₀-aryl, arylalkyl having 1 to 10 C atoms in the alkyl radical and 6 to 20 C atoms in the aryl radical, or SiR^{11A}₃, wherein the organic radicals R^{A},R^{B} can also be substituted by halogens, and/or in each case two radicals R^{A},R^{B} can also be bonded with one another to form a five- or six-membered ring,
R^{C},R^{D} independently of one another denote hydrogen, C₁-C₂₀-alkyl, C₂-C₂₀-alkenyl, C₆-C₂₀-aryl, arylalkyl having 1 to 10 C atoms in the alkyl radical and 6 to 20 C atoms in the aryl radical, or SiR^{11A}₃, wherein the organic radicals R^{C},R^{D} can also be substituted by halogens, and/or in each case two radicals R^{C},R^{D} can also be bonded with one another to form a five- or six-membered ring,
R^{11A} independently of one another denote hydrogen, C₁-C₂₂-alkyl, C₂-C₂₂-alkenyl, C₆-C₂₂-aryl, arylalkyl having 1 to 10 C atoms in the alkyl radical and 6 to 20 C atoms in the aryl radical, and/or two radicals R^{11A} can also be bonded with one another to form a five- or six-membered ring,

According to a preferred embodiment, the at least one iron catalyst is of formula (II):

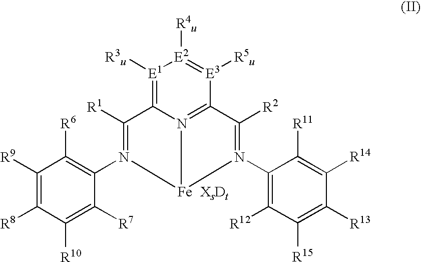

wherein the variables have the following meaning:
R¹-R² independently of one another denote hydrogen, C₁-C₂₂-alkyl, C₂-C₂₂-alkenyl, C₆-C₂₂-aryl, arylalkyl having 1 to 10 C atoms in the alkyl radical and 6-20 C atoms in the aryl radical, or five-, six- or seven-membered heterocyclyl, which comprises at least one atom from the group consisting of N, P, O or S, wherein the organic radicals R¹-R² can also be substituted by halogens, NR¹⁶₂, OR¹⁶ or SiR¹⁷₃ and/or the two radicals R¹-R² can also be bonded with R³-R⁵ to form a five-, six- or seven-membered ring,
R³-R¹⁵ independently of one another denote hydrogen, C₁-C₂₂-alkyl, C₂-C₂₂-alkenyl, C₆-C₂₂-aryl, arylalkyl having 1 to 10 C atoms in the alkyl radical and 6-20 C atoms in the aryl radical, NR¹⁶₂, OR¹⁶, halogen, SiR¹⁷₃ or five-, six- or seven-membered heterocyclyl, which comprises at least one atom from the group consisting of N, P, O or S, wherein the organic radicals R³-R¹⁵ can also be substituted by halogens, NR¹⁶₂, OR¹⁶ or SiR¹⁷₃ and/or in each case two radicals R³-R⁵ can be bonded with one another and/or in each case two radicals R⁶-R¹⁰ can also be bonded with one another to form a five-, six- or seven-membered ring and/or in each case two radicals R¹¹-R¹⁵ can also be bonded with one another to form a five-, six- or seven-membered ring, and/or in each case two radicals R³-R⁵ are bonded with one another and/or in each case two radicals R⁶-R¹⁰ are bonded with one another to form a five-, six- or seven-membered heterocyclyl and/or in each case two radicals R¹¹-R¹⁵ are bonded with one another to form a five-, six- or seven-membered heterocyclyl, which comprises at least one atom from the group consisting of N, P, O or S, wherein at least one of the radicals R⁶-R¹⁵ is chlorine, bromine, iodine, CF₃ or OR¹¹,
   wherein at least one radical R of the group consisting of R⁶-R⁸, and R¹¹-R¹³ is chlorine, bromine, iodine, CF₃ or OR¹¹,
R¹⁶ independently of one another denote hydrogen, C₁-C₂₂-alkyl, C₂-C₂₂-alkenyl, C₆-C₂₂-aryl, arylalkyl having 1 to 10 C atoms in the alkyl radical and 6-20 C atoms in the aryl radical or SiR¹⁷₃, wherein the organic radicals R¹⁶ can also be substituted by halogens and in each case two radicals R¹⁶ can also be bonded to form a five- or six-membered ring,
R¹⁷ independently of one another denote hydrogen, C₁-C₂₂-alkyl, C₂-C₂₂-alkenyl, C₆-C₂₂-aryl or arylalkyl having 1 to 10 C atoms in the alkyl radical and 6-20 C atoms in the aryl radical and in each case two radicals R¹⁷ can also be bonded to form a five- or six-membered ring,
E¹-E³ independently of one another denote carbon, nitrogen or phosphorus, in particular carbon, and
u independently of one another is 0 for E¹-E³ as nitrogen or phosphorus and 1 for E¹-E³ as carbon,
X independently of one another denote fluorine, chlorine, bromine, iodine, hydrogen, C₁-C₁₀-alkyl, C₂-C₁₀-alkenyl, C₆-C₂₀-aryl, arylalkyl having 1-10 C atoms in the alkyl radical and 6-20 C atoms in the aryl radical, wherein the organic radicals X can also be substituted by R¹⁸, NR¹⁸₂, OR¹⁸, SO₃R¹⁸, OC(O)R¹⁸, CN, SCN, β-diketonate, CO, BF₄⁻, PF₆⁻ or bulky non-coordinating anions and wherein the radicals X are optionally/if appropriate bonded with one another,
R¹⁸ independently of one another denote hydrogen, C₁-C₂₀-alkyl, C₂-C₂₀-alkenyl, C₆-C₂₀-aryl, arylalkyl having 1 to 10 C atoms in the alkyl radical and 6-20 C atoms in the aryl radical or SiR¹⁹₃, wherein the organic radicals R¹⁸ can also be substituted by halogens or nitrogen- and oxygen-containing groups and in each case two radicals R¹⁸ can also be bonded to form a five- or six-membered ring,
R¹⁹ independently of one another denote hydrogen, C₁-C₂₀-alkyl, C₂-C₂₀-alkenyl, C₆-C₂₀-aryl or arylalkyl having 1 to 10 C atoms in the alkyl radical and 6-20 C atoms in the aryl radical, wherein the organic radicals R¹⁹ can also be substituted by halogens or nitrogen- and oxygen-containing groups and in each case two radicals R¹⁹ can also be bonded to form a five- or six-membered ring,
s is 1, 2, 3 or 4, in particular 2 or 3,
D is a neutral donor and
t is 0 to 4, in particular 0, 1 or 2.

Accordingly, the present invention also provides a catalyst composition comprising (A) at least one chromium catalyst based on chromium oxide, and (B) at least one iron catalyst of formula (II).

The three atoms E¹-E³ in a molecule can be identical or different. If E¹ is phosphorus, then E² to E³ are preferably each carbon. If E¹ is nitrogen, then E² and E³ are each preferably nitrogen or carbon, in particular carbon.

u independently of one another is 0 for E¹-E³ as nitrogen or phosphorus and 1 for E¹-E³ as carbon.

R¹-R² can be varied within a wide range. Possible carboorganic substituents R¹-R² are, for example, the following: C₁-C₂₂-alkyl which may be linear or branched, e.g. methyl, ethyl, n-propyl, isopropyl, n-butyl, isobutyl, tert-butyl, n-pentyl, n-hexyl, n-heptyl, n-octyl, n-nonyl, n-decyl or n-dodecyl, 5- to 7-membered cycloalkyl which may in turn bear a C₁-C₁₀-alkyl group and/or C₆-C₁₀-aryl group as substituents, e.g. cyclopropyl, cyclobutyl, cyclopentyl, cyclohexyl, cycloheptyl, cyclooctyl, cyclononyl or cyclododecyl, C₂-C₂₂-alkenyl which may be linear, cyclic or branched and in which the double bond may be internal or terminal, e.g. vinyl, 1-allyl, 2-allyl, 3-allyl, butenyl, pentenyl, hexenyl, cyclopentenyl, cyclohexenyl, cyclooctenyl or cyclooctadienyl, C₆-C₂₂-aryl which may be substituted by further alkyl groups, e.g. phenyl, naphthyl, biphenyl, anthranyl, o-, m-, p-methylphenyl, 2,3-, 2,4-, 2,5- or 2,6-dimethylphenyl, 2,3,4-, 2,3,5-, 2,3,6-, 2,4,5-, 2,4,6- or 3,4,5-trimethylphenyl, or arylalkyl which may be substituted by further alkyl groups, e.g. benzyl, o-, m-, p-methylbenzyl, 1- or 2-ethylphenyl, where two radicals R¹-R² may also be joined to form a 5-, 6- or 7-membered ring and/or two of the vicinal radicals R¹-R² may be joined to form a five-, six- or seven-membered heterocycle containing at least one atom from the group consisting of N, P, O and S and/or the organic radicals R¹-R² may also be substituted by halogens such as fluorine, chlorine or bromine. Furthermore, R³-R¹⁵ can also be amino NR¹⁶₂ or SiR¹⁷₃, alkoxy or aryloxy OR¹⁶, for example dimethylamino, N-pyrrolidinyl, picolinyl, methoxy, ethoxy or isopropoxy or halogen such as fluorine, chlorine or bromine. Further possible radicals R¹⁶ and R^{/7} are more fully described below. Two R¹⁶ and/or R¹⁷ may also be joined to form a 5- or 6-membered ring. The SiR¹⁷₃ radicals may also be bound to E¹-E³ via an oxygen or nitrogen. Examples for R¹⁷ are trimethylsilyloxy, triethylsilyloxy, butyldimethylsilyloxy, tributylsilyloxy or tri-tert-butylsilyloxy.

The substituents R³-R¹⁵ can be varied within a wide range, as long as at least one radical R of R⁶-R¹⁵ is chlorine, bromine, and iodine, CF₃ or OR¹¹. Possible carboorganic substituents R³-R¹⁵ are, for example, the following: C₁-C₂₂-alkyl which may be linear or branched, e.g. methyl, ethyl, n-propyl, isopropyl, n-butyl, isobutyl, tert-butyl, n-pentyl, n-hexyl, n-heptyl, n-octyl, n-nonyl, n-decyl or n-dodecyl, 5- to 7-membered cycloalkyl which may in turn bear a C₁-C₁₀-alkyl group and/or C₆-C₁₀-aryl group as substituents, e.g. cyclopropyl, cyclobutyl, cyclopentyl, cyclohexyl, cycloheptyl, cyclooctyl, cyclononyl or cyclododecyl, C₂-C₂₂-alkenyl which may be linear, cyclic or branched and in which the double bond may be internal or terminal, e.g. vinyl, 1-allyl, 2-allyl, 3-allyl, butenyl, pentenyl, hexenyl, cyclopentenyl, cyclohexenyl, cyclooctenyl or cyclooctadienyl, C₆-C₂₂-aryl which may be substituted by further alkyl groups, e.g. phenyl, naphthyl, biphenyl, anthranyl, o-, m-, p-methylphenyl, 2,3-, 2,4-, 2,5- or 2,6-dimethylphenyl, 2,3,4-, 2,3,5-, 2,3,6-, 2,4,5-, 2,4,6- or 3,4,5-trimethylphenyl, or arylalkyl which may be substituted by further alkyl groups, e.g. benzyl, o-, m-, p-methylbenzyl, 1- or 2-ethylphenyl, where two radicals R³-R⁵ and/or two vicinal radicals R⁶-R¹⁵ may also be joined to form a 5-, 6- or 7-membered ring and/or two of the vicinal radicals R³-R⁵ and/or two of the vicinal radicals R⁶-R¹⁵ may be joined to form a five-, six- or seven-membered heterocycle containing at least one atom from the group consisting of N, P, O and S and/or the organic radicals R³-R⁵ and/or R⁶-R¹⁵ may also be substituted by halogens such as fluorine, chlorine or bromine. Furthermore, R³-R¹⁵ can also be amino NR¹⁸₂ or SiR¹⁷₃, alkoxy or aryloxy OR¹⁶, for example dimethylamino, N-pyrrolidinyl, picolinyl, methoxy, ethoxy or isopropoxy or halogen such as fluorine, chlorine or bromine. Further possible radicals R¹⁶ and R¹⁷ are more fully described below. Two R¹⁶ and/or R¹⁷ may also be joined to form a 5- or 6-membered ring. The SiR¹⁷₃ radicals may also be bound to E¹-E³ via an oxygen or nitrogen. Examples for R¹⁷ are trimethylsilyloxy, triethylsilyloxy, butyldimethylsilyloxy, tributylsilyloxy or tri-tert-butylsilyloxy.

Preferred radicals R³-R⁵ are hydrogen, methyl, trifluoromethyl, ethyl, n-propyl, isopropyl, n-butyl, isobutyl, tert-butyl, n-pentyl, n-hexyl, n-heptyl, n-octyl, vinyl, allyl, benzyl, phenyl, ortho-dialkyl- or -dichloro-substituted phenyls, trialkyl- or trichloro-substituted phenyls, naphthyl, biphenyl and anthranyl. Particularly preferred organosilicon substituents are trialkylsilyl groups having from 1 to 10 carbon atoms in the alkyl radical, in particular trimethylsilyl groups.

Preferred radicals R⁶-R¹⁵ are hydrogen, methyl, trifluoromethyl, ethyl, n-propyl, isopropyl, n-butyl, isobutyl, tert-butyl, n-pentyl, n-hexyl, n-heptyl, n-octyl, vinyl, allyl, benzyl, phenyl, fluorine, chlorine and bromine, wherein at least one of the radicals R⁶-R¹⁵ is chlorine, bromine, iodine, CF₃ or OR¹¹.

Preferably, at least one radical R of the group consisting of R⁶-R⁸, and R¹¹-R¹³ is chlorine, bromine, or CF₃ and at least one radical R of the group consisting of R⁶-R⁸, and R¹¹-R¹³ is hydrogen, or C₁-C₄-alkyl, wherein the alkyl can be linear or branched, in particular, methyl, ethyl, n-propyl, iso-propyl, n-butyl, iso-butyl, or tert.-butyl.

In particular, at least one radical R of the group consisting of R⁶-R⁸, and R¹¹-R¹³ is chlorine or bromine and at least one radical R of the group consisting of R⁶-R⁸, and R¹¹-R¹³ is hydrogen, or methyl.

Preferably, R⁶ and/or R¹¹ are chlorine or bromine and R⁷, R⁸, R¹² and/or R¹³ are hydrogen, or methyl. In another preferred embodiment of the invention, R⁶ and R⁸, and/or R¹¹ and R¹³ are chlorine or bromine, and R⁷ and/or R¹², are hydrogen or methyl. In a further preferred embodiment R⁶ and R¹¹ are identical, and/or R⁷ and R¹² are identical, and/or R⁸ and R¹³ are identical, wherein at least one pair of identical rests R is chlorine or bromine. In another preferred embodiment R⁶ and R¹¹ are different, and/or R⁷ and R¹² are different, and/or R⁸ and R¹³ are different, wherein at least rest R is chlorine or bromine. Particular preference is given to iron components in which at least one rest R R⁶-R⁸, and/or R¹¹-R¹³ is chlorine.

In particular, at least one radical R of the group consisting of R⁹, R¹⁰, R¹⁴, and R¹⁵ is hydrogen, or C₁-C₂₂-alkyl which may also be substituted by halogens, e.g. methyl, trifluoromethyl, ethyl, n-propyl, n-butyl, n-pentyl, n-hexyl, n-heptyl, n-octyl, or vinyl. Particular preference is given to R⁹, R¹⁰, R¹⁴, and R¹⁵ being hydrogen, or methyl, ethyl, n-propyl, n-butyl, preferably hydrogen. Especially, R⁹, R¹⁰, R¹⁴, and R¹⁵ are identical.

Variation of the radicals R¹⁶ enables, for example, physical properties such as solubility to be finely adjusted. Possible carboorganic substituents R¹⁶ are, for example, the following: C₁-C₂₀-alkyl which may be linear or branched, e.g. methyl, ethyl, n-propyl, isopropyl, n-butyl, isobutyl, tert-butyl, n-pentyl, n-hexyl, n-heptyl, n-octyl, n-nonyl, n-decyl or n-dodecyl, 5- to 7-membered cycloalkyl which may in turn bear a C₆-C₁₀-aryl group as substituent, e.g. cyclopropyl, cyclobutyl, cyclopentyl, cyclohexyl, cycloheptyl, cyclooctyl, cyclononyl or cyclododecyl, C₂-C₂₀-alkenyl which may be linear, cyclic or branched and in which the double bond may be internal or terminal, e.g. vinyl, 1-allyl, 2-allyl, 3-allyl, butenyl, pentenyl, hexenyl, cyclopentenyl, cyclohexenyl, cyclooctenyl or cyclooctadienyl, C₆-C₂₀-aryl which may be substituted by further alkyl groups and/or N- or O-containing radicals, e.g. phenyl, naphthyl, biphenyl, anthranyl, o-, m-, p-methylphenyl, 2,3-, 2,4-, 2,5- or 2,6-dimethylphenyl, 2,3,4-, 2,3,5-, 2,3,6-, 2,4,5-, 2,4,6- or 3,4,5-trimethylphenyl, 2-methoxyphenyl, 2-N,N-dimethylaminophenyl, or arylalkyl which may be substituted by further alkyl groups, e.g. benzyl, o-, m-, p-methylbenzyl, 1- or 2-ethylphenyl, where two radicals R¹⁶ may also be joined to form a 5- or 6-membered ring and the organic radicals R¹⁶ may also be substituted by halogens such as fluorine, chlorine or bromine.

Possible radicals R¹⁷ in organosilicon substituents SiR¹⁷₃ are the same radicals which have been described above for R¹-R², where two radicals R¹⁷ may also be joined to form a 5- or 6-membered ring, e.g. trimethylsilyl, triethylsilyl, butyldimethylsilyl, tributylsilyl, triallylsilyl, triphenylsilyl or dimethylphenylsilyl. Preference is given to using C₁-C₁₀-alkyl such as methyl, ethyl, n-propyl, n-butyl, tert-butyl, n-pentyl, n-hexyl, n-heptyl, n-octyl, and also vinyl allyl, benzyl and phenyl as radicals R¹⁷.

The ligands X result, for example, from the choice of the appropriate starting metal compounds used for the synthesis of the iron complexes, but can also be varied afterward. Possible ligands X are, in particular, the halogens such as fluorine, chlorine, bromine or iodine, in particular chlorine. Alkyl radicals such as methyl, ethyl, propyl, butyl, vinyl, allyl, phenyl or benzyl are also usable ligands X, wherein the organic radicals X can also be substituted by R¹⁸. As further ligands X, mention may be made, purely by way of example and in no way exhaustively, of trifluoroacetate, BF₄⁻, PF₆⁻ and weakly coordinating or non-coordinating anions (cf., for example, S. Strauss in Chem. Rev. 1993, 93, 927-942), e.g. B(C₆F₅)₄⁻. Amides, alkoxides, sulfonates, carboxylates and β-diketonates are also particularly useful ligands X. Some of these substituted ligands X are particularly preferably used since they are obtainable from cheap and readily available starting materials. Thus, a particularly preferred embodiment is that in which X is dimethylamide, methoxide, ethoxide, isopropoxide, phenoxide, naphthoxide, triflate, p-toluenesulfonate, acetate or acetylacetonate.

The number s of the ligands X depends on the oxidation state of the iron. The number s can thus not be given in general terms. The oxidation state of the iron in catalytically active complexes is usually known to those skilled in the art. However, it is also possible to use complexes whose oxidation state does not correspond to that of the active catalyst. Such complexes can then be appropriately reduced or oxidized by means of suitable activators. Preference is given to using iron complexes in the oxidation state +3 or +2.

D is an uncharged donor, in particular an uncharged Lewis base or Lewis acid, for example amines, alcohols, ethers, ketones, aldehydes, esters, sulfides or phosphines which may be bound to the iron centre or else still be present as residual solvent from the preparation of the iron complexes.

The number t of the ligands D can be from 0 to 4 and is often dependent on the solvent in which the iron complex is prepared and the time for which the resulting complexes are dried and can therefore also be a non-integer number such as 0.5 or 1.5. In particular, t is 0, 1 to 2.

Preferred complexes (B) are 2,6-bis[1-(2-chloro-4,6-dimethylphenylimino)ethyl]pyridine iron(II) chloride; 2,6-bis[1-(2-chloro-6-methylphenylimino)ethyl]pyridine iron(II) dichloride, 2,6-bis[1-(2,6-dichlorophenylimino)ethyl]pyridine iron(II) dichloride, 2,6-bis[1-(2,4-dichloro-6-methyl-phenylimino)ethyl]pyridine iron(II) dichloride, 2,6-bis[1-(2,6-difluorophenylimino)ethyl]-pyridine iron(II) dichloride, 2,6-bis[1-(2,6-dibromophenylimino)ethyl]-pyridine iron(II) dichloride or the respective dibromides or tribromides.

The preparation of the iron complexes (B) is described, for example, in J. Am. Chem. Soc. 120, p. 4049 ff. (1998), J. Chem. Soc., Chem. Commun. 1998, 849, and WO 98/27124.

Generally, all chromium catalysts based on chromium oxide can be used to prepare catalyst (A) of the catalyst composition of the invention, provided they give rise, together with iron catalyst (B), to an ethylene copolymer having the features defined in attached claim 1. Generally, these chromium catalysts are also referred to as Phillips catalysts and are well-known in the art (for instance, their composition and mode of preparation is described in M. P. McDaniel, Adv. Cat 33, 7-98 (1985), U.S. Pat. No. 5,363,915, all of which are incorporated herein by reference. Preferably, supported chromium oxide or Phillips catalysts are used.

Chromium catalysts based on chromium oxide are well known in the art and commercially available from a number of producers. As is known, chromium catalysts are generally produced by doping inorganic supports such as silica gels or aluminum oxides with chromium (catalyst precursors) with the active component containing chromium preferably from a solution or, in the case of volatile compounds, from the vapour phase. Suitable chromium compounds are chromium(VI) oxide, chromium salts such as chromium(III) nitrate and chromium(III) acetate, complex compounds such as chromium(III) acetylacetonate or chromium hexacarbonyl, or alternatively organometallic compounds of chromium such as bis(cyclopentadienyl)chromium(II), organic chromic esters or bis(aren)chromium(0). Cr(III) nitrate is preferably used. To obtain a polymerization-active catalyst, this chromium-doped catalyst precursor is thermally treated at predetermined temperatures, preferably from 500 and 900° C., more preferably from 550 to 650° C., in an oxidizing atmosphere, preferably in air. According to a preferred embodiment of the process for preparing the chromium catalyst, the oxidised catalyst precursor may be subjected to a pre-reduction step by means of a reducing agent, such as for example carbon monoxide or hydrogen. This pre-reduction step is preferably performed at a temperature within the range of 300 to 400° C., more preferably from 320 to 480° C., preferably during a period from 5 minutes to 48 hours, more preferably from 1 to 10 hours.

The molar ratio of chromium catalyst (A) to iron catalyst (B) is usually in the range from 1:100 to 100:1, preferably from 1:10 to 10:1 and particularly preferably from 1:5 to 5:1. The preferred embodiments of (A) and (B) are likewise preferred in combinations of (A) and (B).

The catalyst composition of the invention can be used alone or together with further components as catalyst system for olefin polymerization. Accordingly, the present invention also provides a catalyst system comprising, additionally to the catalysts (A) and (B), at least one organic or inorganic support (H), and/or at least one activating compound (J), and/or at least one metal compound of a metal of group 1, 2 or 13 of the Periodic Table (K).

As possible support materials, preference is given to using silica gel, magnesium chloride, aluminum oxide, mesoporous materials, aluminosilicates, hydrotalcites and organic polymers such as polyethylene, polypropylene, polystyrene, polytetrafluoroethylene or polymers bearing polar functional groups, for example copolymers of ethene and acrylic esters, acrolein or vinyl acetate. In a preferred embodiment of the invention, a supported chromium catalyst and a supported iron catalyst is used. In an especially preferred embodiment the chromium catalyst and the iron catalyst are on the same, common support in order to ensure a relatively close spatial proximity of the different catalyst centres and thus to ensure good mixing of the different polymers formed.

Preference is given to using finely divided supports (H) which can be any organic or inorganic, inert solid. In particular, the support (H) can be a porous support such as talc, a sheet silicate, or an inorganic oxide. The support (H) preferably used has a specific surface area in the range from 10 to 1000 m²/g, preferably from 200 to 400 m²/g, and preferably a pore volume in the range from 0.1 to 5 ml/g. The mean particle size of the finely divided support is generally in the range from 1 to 500 μm, particularly from 30 to 70 μm.

Inorganic oxides suitable as supports (H) may be found among oxides of the elements of groups 2, 3, 4, 5, 13, 14, 15 and 16 of the Periodic Table of the Elements. Preference is given to oxides or mixed oxides of the elements calcium, aluminum, silicon, magnesium or titanium and also corresponding oxide mixtures; optionally one may also use ZrO₂ or B₂O₃. Preferred oxides are silicon dioxide, in particular in the form of a silica gel or a pyrogenic silica, or aluminum oxide. Examples of particularly preferred supports are spray dried SiO₂, especially those having a pore volume of from 1.0 to 3.0 ml/g, preferably from 1.2 to 2.2 ml/g and more preferably from 1.4 to 1.9 ml/g and a surface area (BET) of from 100 to 500 m²/g and preferably from 200 to 400 m²/g. Such products are commercially available, for example as Silica XPO 2107 sold by Grace.

The inorganic support (H) can be subjected to a thermal treatment, e.g. for removing adsorbed water. Such a drying treatment is generally carried out at from 80 to 300° C., preferably from 100 to 200° C., and is preferably carried out under reduced pressure and/or in a stream of inert gas, for example nitrogen or argon. The inorganic support (H) can also be calcined, in which case the concentration of OH groups on the surface is adjusted and the structure of the solid may be altered by a treatment at from 200 to 1000° C. The support can also be treated chemically using customary desiccants such as metal alkyls, preferably aluminum alkyls, chlorosilanes or SiCl₄, or else methyl-aluminoxane. Appropriate treatment methods are described, for example, in WO 00/31090. The inorganic support (H) can also be chemically modified. For example, the treatment of silica gel with NH₄SiF₆ leads to fluorination of the silica gel surface; likewise treatment of silica gels with silanes containing nitrogen-, fluorine- or sulfur-containing groups gives correspondingly modified silica gel surfaces.

The support (H) is generally loaded by contacting it, in a solvent, with a chromium compound, removing the solvent and calcining the catalyst at a temperature of from 400 to 1100° C. The support (H) can for this purpose be suspended in a solvent or in a solution of the chromium compound. The ratio by weight of chromium compounds to the support during application is generally from 0.001:1 to 200:1, preferably from 0.005:1 to 100:1.

According to a preferred embodiment, the chromium catalyst (A) is prepared by adding small amounts of MgO and/or ZnO to the inactive pre-catalyst and subsequently activating this mixture in conventional manner. This measure improves the electrostatic properties of the catalyst. For activation, the dry pre-catalyst of catalyst (A) is calcined at temperatures between 400 and 1100° C., for example in a fluidized-bed reactor in an oxidizing atmosphere containing oxygen. Cooling preferably takes place under an inert gas atmosphere in order to prevent adsorption of oxygen. It is also possible to carry out this calcination in the presence of fluorine compounds, such as ammonium hexafluorosilicate, by which means the catalyst surface is modified with fluorine atoms. Calcination of the pre-stage preferably takes place in a vapour-phase fluidized bed. According to one preferred embodiment, the mixture is first heated to from 200 to 400° C., preferably to from 250 to 350° C., with fluidization thereof by pure inert gas, preferably nitrogen, which is subsequently replaced by air, whereupon the mixture is heated to the desired end temperature. The mixture is kept at the end temperature for a period of from 2 to 20 hours and preferably from 5 to 15 hours, after which the flow of gas is switched back to inert gas, and the mixture is cooled. According to a preferred embodiment, a supported chromium catalyst (A) is used which has been activated at a temperature of from 600 to 800° C.

Particular preference is given to a catalyst system comprising at least one chromium catalyst (A), at least one iron catalyst (B), at least one support component (H), and preferably at least one activating compound (J).

In a preferred embodiment of the invention, the catalyst system comprises at least one activating compound (J). Such activating compound is preferably used in an excess or in stoichiometric amounts based on the catalysts which they activate. In general, the molar ratio of catalyst to activating compound (J) can be from 1:0.1 to 1:10000. Such activator compounds are uncharged, strong Lewis acids, ionic compounds having a Lewis-acid cation or a ionic compound containing a Brönsted acid as cation in general. Further details on suitable activators of the polymerization catalysts of the present invention, especially on definition of strong, uncharged Lewis acids and Lewis acid cations, and preferred embodiments of such activators, their mode of preparation as well as particularities and the stoichiometry of using them have already been set forth in detail in WO05/103096 from the same applicant. Examples are aluminoxanes, hydroxyaluminoxanes, boranes, boroxins, boronic acids and borinic acids. Further examples of strong, uncharged Lewis acids for use as activating compounds are given in WO 03/31090 and WO05/103096 incorporated hereto by reference.

Suitable activating compounds (J) are both as an example and as a strongly preferred embodiment, compounds such as an aluminoxane, a strong uncharged Lewis acid, an ionic compound having a Lewis-acid cation or an ionic compound containing. As aluminoxanes, it is possible to use, for example, the compounds described in WO 00/31090 incorporated hereto by reference. Particularly useful aluminoxanes are open-chain or cyclic aluminoxane compounds of the general formula (III) or (IV)

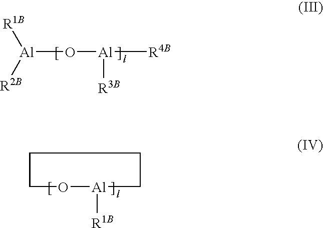

where R^{1B}-R^{4B} are each, independently of one another, a C₁-C₆-alkyl group, preferably a methyl, ethyl, butyl or isobutyl group and I is an integer from 1 to 40, preferably from 4 to 25.

A particularly useful aluminoxane compound is methyl aluminoxane (MAO).

Furthermore modified aluminoxanes in which some of the hydrocarbon radicals have been replaced by hydrogen atoms or alkoxy, aryloxy, siloxy or amide radicals can also be used in place of the aluminoxane compounds of the formula (III) or (IV) as activating compound (J).

Boranes and boroxines are particularly useful as activating compound (J), such as trialkylborane, triarylborane or trimethylboroxine. Particular preference is given to using boranes which bear at least two perfluorinated aryl radicals. More preferably, a compound selected from the list consisting of triphenylborane, tris(4-fluorophenyl)borane, tris(3,5-difluorophenyl)borane, tris(4-fluoromethylphenyl)borane, tris(pentafluorophenyl)borane, tris(tolyl)borane, tris(3,5-dimethylphenyl)borane, tris(3,5-difluorophenyl)borane or tris(3,4,5-trifluorophenyl)borane is used, most preferably the activating compound is tris(pentafluorophenyl)borane. Particular mention is also made of borinic acids having perfluorinated aryl radicals, for example (C₆F₅)₂BOH. More generic definitions of suitable Bor-based Lewis acids compounds that can be used as activating compounds (J) are given WO05/103096 incorporated hereto by reference, as said above.

Compounds containing anionic boron heterocycles as described in WO 9736937 incorporated hereto by reference, such as for example dimethyl anilino borato benzenes or trityl borato benzenes, can also be used suitably as activating compounds (J). Preferred ionic activating compounds (J) can contain borates bearing at least two perfluorinated aryl radicals. Particular preference is given to N,N-dimethyl anilino tetrakis(pentafluorophenyl)borate and in particular N,N-dimethylcyclohexylammonium tetrakis(pentafluorophenyl)borate, N,N-dimethylbenzyl-ammonium tetrakis(pentafluorophenyl)borate or trityl tetrakispentafluorophenylborate. It is also possible for two or more borate anions to be joined to one another, as in the dianion [(C₆F₅)₂B—C₆F₄—B(C₆F₅)₂]²⁻, or the borate anion can be bound via a bridge to a suitable functional group on the support surface. Further suitable activating compounds (J) are listed in WO 00/31090, here incorporated by reference.

Further specially preferred activating compounds (J) preferably include boron-aluminum compounds such as di[bis(pentafluorophenylboroxy)]methylalane. Examples of such boron-aluminum compounds are those disclosed in WO 99/06414 incorporated hereto by reference. It is also possible to use mixtures of all the above-mentioned activating compounds (J). Preferred mixtures comprise aluminoxanes, in particular methylaluminoxane, and an ionic compound, in particular one containing the tetrakis(pentafluorophenyl)borate anion, and/or a strong uncharged Lewis acid, in particular tris(pentafluorophenyl)borane or a boroxin.

The catalyst system may further comprise, as additional component (K), a metal compound as defined both by way of generic formula, its mode and stoichiometrie of use and specific examples in WO 05/103096, incorporated hereto by reference. The metal compound (K) can likewise be reacted in any order with the catalysts (A) and (B) and optionally with the activating compound (J) and the support (H).

The order in which support (H), chromium catalyst (A), iron catalyst (B) and the activating compounds (J) can be combined is in principle immaterial. After the individual process steps, the various intermediates can be washed with suitable inert solvents such as aliphatic or aromatic hydrocarbons. The supported catalyst is preferably obtained as a free-flowing powder. Examples of the industrial implementation of the above process are described in WO 96/00243, WO 98/40419 or WO 00/05277. A further method of immobilization is prepolymerization of the catalyst system with or without prior application to a support. The chromium catalyst (A) and the iron catalyst (B) may be contacted with the olefin to be polymerized in the form of a single catalyst system, for example a catalyst system according to any of the preferred embodiments optionally comprising further component as described above, or they may be added to the reactor separately.

The chromium catalyst (A) is preferably applied in such an amount that the concentration of the chromium from the chromium catalyst (A) in the finished catalyst system is from 1 to 200 μmol, preferably from 5 to 100 μmol and particularly preferably from 10 to 70 μmol, per g of support (H). The iron catalyst (B) is preferably applied in such an amount that the concentration of iron from the iron catalyst (B) in the finished catalyst system is from 1 to 200 μmol, preferably from 5 to 100 μmol and particularly preferably from 10 to 70 μmol, per g of support (H).

It is also possible for the catalyst system firstly to be prepolymerized with alpha-olefins, preferably linear C₂-C₁₀-1-alkenes and more preferably ethylene or propylene, and the resulting prepolymerized catalyst solid then to be used in the actual polymerization. The mass ratio of catalyst solid used in the prepolymerization to a monomer polymerized onto it is preferably in the range from 1:0.1 to 1:1000, preferably from 1:1 to 1:200. Furthermore, a small amount of an olefin, preferably an alpha-olefin, for example vinylcyclohexane, styrene or phenyldimethylvinylsilane, as modifying component, an antistatic or a suitable inert compound such as a wax or oil can be added as additive during or after the preparation of the catalyst system. The molar ratio of additives to the sum of chromium catalyst (A) and iron catalyst (B) is usually from 1:1000 to 1000:1, preferably from 1:5 to 20:1.

The present invention provides the use of the above-mentioned catalyst composition for the polymerization of ethylene, and a process for preparing the multimodal polyethylene of the invention comprising the step of copolymerizing ethylene with at least one alpha-olefin.

Accordingly, the present invention further provides a process for polymerization of olefins in the presence of the catalyst composition of the invention.

Preferably, in the copolymerization process of the invention, ethylene is polymerized with alpha-olefins preferably having from 3 to 12 carbon atoms. Preferred alpha-olefins are linear or branched C₂-C₁₂-1-alkenes, in particular linear C₂-C₁₀-1-alkenes such as ethene, propene, 1-butene, 1-pentene, 1-hexene, 1-heptene, 1-octene, 1-decene or branched C₂-C₁₀-1-alkenes such as 4-methyl-1-pentene. Particularly preferred 1-olefins are C₄-C₁₂-1-alkenes, in particular linear C₆-C₁₀-1-alkenes. It is also possible to polymerize mixtures of various 1-olefins. Preference is given to polymerizing at least one alpha-olefin selected from the group consisting of ethene, propene, 1-butene, 1-pentene, 1-hexene, 1-heptene, 1-octene and 1-decene. Monomer mixtures containing at least 50 mol % of ethene are preferably used.

The process of the invention for polymerizing ethylene with alpha-olefins can be carried out using industrially known polymerization methods at temperatures, preferably in the range from −60 to 350° C., more preferably in the range from 20 to 300° C., and still more preferably from 25 to 150° C., and preferably under pressures of from 0.5 to 4000 bar, more preferably from 1 to 100 bar and most preferably from 3 to 40 bar. The polymerization can be carried out in a known manner in bulk, in suspension, in the gas phase or in a supercritical medium in the customary reactors used for the polymerization of olefins. The polymerization can be carried out batchwise or preferably continuously in one or more stages. High-pressure polymerization processes in tube reactors or autoclaves, solution processes, suspension processes, stirred gas-phase processes and gas-phase fluidized-bed processes are all possible.

The mean residence times are preferably from 0.5 to 5 hours, more preferably from 0.5 to 3 hours. As is known in the art, the more suitable pressure and temperature ranges for carrying out the polymerizations usually depend on the polymerization method. In the case of high-pressure polymerization processes, which are preferably carried out at pressures of from 1000 to 4000 bar, in particular from 2000 to 3500 bar, high polymerization temperatures are preferably also set. Preferred temperature ranges for these high-pressure polymerization processes are from 200 to 320° C., more preferably from 220 to 290° C. In the case of low-pressure polymerization processes, it is preferred to set a temperature which is at least a few degrees below the softening temperature of the polymer. In particular, temperatures of from 50 to 180° C., preferably from 70 to 120° C., are preferably set in these polymerization processes. In the case of suspension polymerizations, the polymerization is preferably carried out in a suspension medium, preferably an inert hydrocarbon such as isobutane or mixtures of hydrocarbons or else in the monomers themselves. The polymerization temperatures are preferably in the range from −20 to 115° C., and the pressure is generally in the range from 1 to 100 bar. The solids content of the suspension is generally in the range from 10 to 80%. The polymerization can be carried out either batchwise, e.g. in stirring autoclaves, or continuously, e.g. in tube reactors, preferably in loop reactors. Particular preference is given to employing the Phillips PF process as described in U.S. Pat. No. 3,242,150 and U.S. Pat. No. 3,248,179. The gas-phase polymerization is preferably carried out in the temperature range from 30 to 125° C., and preferably at pressures of from 1 to 50 bar.

Among the above-mentioned alternative polymerization processes, particular preference is given to gas-phase polymerization, preferably carried out in gas-phase fluidized-bed reactors, to solution polymerization and to suspension polymerization, preferably in loop reactors and stirred tank reactors. The gas-phase polymerization can also be carried out in the condensed or supercondensed mode, in which part of the circulating gas is cooled to below the dew point and is recirculated as a two-phase mixture to the reactor. According to a further alternative embodiment, it is possible to use a multizone reactor comprising two distinct polymerization zones connected to one another, by passing the polymer alternately through these two zones a predetermined number of times. The two zones preferably have different polymerization conditions, so as to perform two different polymerization stages. Such a reactor is described, for example, in WO 97/04015. The different or identical polymerization stages can also, if desired, be connected in series so as to form a polymerization cascade in two reactors arranged in series. A parallel reactor arrangement using two or more identical or different processes is also possible. Furthermore, molar mass regulators, for example hydrogen, or customary additives such as antistatics can also be used in the polymerizations. To obtain a high proportion of vinyl groups, the polymerization is preferably carried out with smaller amounts or no hydrogen present.

The polymerization is preferably carried out in a single reactor, in particular in a gas-phase reactor. The polymerization of ethylene with alpha-olefins preferably having from 3 to 12 carbon atoms allows to prepare the multimodal polyethylene of the invention when the catalyst composition of the invention is used. The polyethylene powder obtained directly from the reactor displays a very high homogeneity, so that, unlike the case of cascade processes, subsequent extrusion is not necessary in order to obtain a homogeneous product. The preparation of the multimodal polyethylene of the invention in the reactor advantageously reduces the energy consumption, requires no subsequent blending processes and makes simple control of the molecular mass distributions and the molecular mass fractions of the various polymers possible. In addition, good mixing of the polyethylenes is achieved.

### EXAMPLES

The following examples illustrate the invention without restricting the scope thereof.

All percentages of single components mentioned in the present application, unless otherwise indicated, are based on weight, based on the total weight of the corresponding composition or mixtures comprising those components.

In the present description and in the following claims, the parameters used were determined in the following way.

The density [g/cm³] was determined in accordance with ISO 1183.

The melt flow rate MFR₂₁ was determined according to ISO 1133 at a temperature of 190° C. under a load of 21.6 kg (190° C./21.6 kg).

The melt flow rate MFR₅ was determined according to ISO 1133 at a temperature of 190° C. under a load of 5 kg (190° C./5 kg).

The intrinsic viscosity was determined in accordance with EN ISO 1628-1.

The determination of the weight average molar mass M_{w}, number average molar mass Mₙ, and polidispersity M_{w}/Mₙ derived there from was carried out by means of high-temperature gel permeation chromatography on a WATERS 150 C using a method based on DIN 55672-1 (version 1995-02 of issue February 1995) and the following columns connected in series: 3× SHODEX AT 806 MS, 1× SHODEX UT 807 and 1× SHODEX AT-G under the following conditions: solvent: 1,2,4-trichlorobenzene (stabilized with 0.025% by weight of 2,6-di-tert-butyl-4-methylphenol), flow: 1 ml/min, 500 μl injection volume, temperature: 135° C., calibration using PE Standards. Evaluation was carried out using WIN-GPC.

The vinyl group content was determined by means of IR in accordance with ASTM D 6248-98.

The branches/1000 carbon atoms were determined by means of ¹³C-NMR, as described by James C. Randall, JMS-REV. Macromol. Chem. Phys., C29 (2&3), 201-317 (1989), and were based on the total content of CH₃ groups/1000 carbon atoms including end groups. The side chains larger than CH₃ and especially ethyl, butyl and hexyl side chain branches/1000 carbon atoms excluding end groups were likewise determined in this way.

The degree of branching in the individual polymer fractions was determined by the method of Holtrup (W. Holtrup, Makromol. Chem. 178, 2335 (1977)) coupled with ¹³C-NMR. as described by James C. Randall, JMS-REV. Macromol. Chem. Phys., C29 (2&3), 201-317 (1989).

The content of comonomer side chains/1000 carbon atoms was determined by means of infrared spectroscopy by use of an FTIR 2000 of Perkin Elmer, and is based on the total CH₃ group content/1000 carbon atoms including end groups. The comonomer content was determined by multiple variate data analysis.

Heptane and toluene have been dried over molecular sieves.

### Example 1

### Preparation of a Supported Chromium Catalyst

150 g of supported chromium (0.3% by weight on support) were used. The support used was a spray dried SiO₂ support having a surface area (BET) of 300 m²/g and a pore volume of 1.60 ml/g.

Such a support is available commercially from Grace under the name XP02107. To 135 kg of such a support were added 192 l of a solution of Cr(N0₃)₃9H₂0 in methanol (17 g/l) were added, and after 1 hour the solvent was removed by distillation under reduced pressure (900-300 mbar) at 70-75° C. The resulting intermediate contained 0.3 wt % of chromium.

100 g of the support so treated was placed in a quartz activator, which was heated under nitrogen stream (130 l/h) during 5 h up to 550° C. At 300° C. the gas switched automatically from nitrogen stream to air stream (130 l/h). The temperature was kept for 2 h at 550° C. Then during 5 h the quartz activator was cooled down under air stream, wherein the gas switched automatically from air stream to nitrogen stream at 300° C. 62 g of chromium catalyst were obtained.

### Example 2

### Prepolymerization of the Chromium Catalyst of Example 1

37 g of chromium catalyst prepared in Example 1 were suspended in 650 ml heptane in a 1-1 four-necked flask provided with contact thermometer, Teflon blade stirrer, gas inlet tube, condenser and heating mantle. The suspension was heated to 63° C., and ethylene was fed in for 60 minutes (8 l/h) at this temperature. The colour changed from brown-beige (Cr^{VI}) to olive-green (Cr^{II-III}). The not dissolved ethylene was fumigated with argon. The suspension was transferred to a glass filter frit and washed with 500 ml heptane. The product was dried at 0 mbar until weight constancy. Percentage of polymer was 24% by weight of total product.

### Example 3

### Preparation of 2,6-bis[1-(2-chloro-4,6-dimethylphenylimino)ethyl]pyridine iron(II) chloride

35.0 g 2,6-diacetylpyridine (0.215 mol), 50 g of Sicapent® (phosphorus(V) oxide, phosphoric anhydride) and 76.8 g (0.493 mol) 2-chloro-4,6-dimethylaniline were dissolved in 1500 ml of THF. The mixture was heated under reflux conditions for 42 hours. The amount of product reached 71.2% (GC/MS). The mixture was subsequently filtered at room temperature. The filter cake was washed with 50 ml of THF. The solvent of the combined filtrates was distilled off. 250 ml of methanol were added and the mixture is stirred for 1 hour. A yellow suspension formed and the product was isolated by filtration. The filter cake (product) was washed with methanol (2×20 ml) and subsequently dried. 58 g of the ligand was isolated. The ligand was dissolved in THF. FeCl₂*4H₂O was added and the mixture was stirred for about 4 h at room temperature. A blue precipitate formed. The complex was isolated by filtration (room temperature) of the blue suspension. The filter cake (product) was washed with pentane and subsequently dried. 46 g of complex were isolated.

### Example 4

### Doping of Prepolymerized Chromium Catalyst of Example 2 with Iron Catalyst of Example 3

14.6 g prepolymerized catalyst of Example 2 were placed in a 250 ml-four-necked flask and a suspension of 0.1487 g 2,6-bis[(2-chloro-4,6-dimethylphenylimino)ethyl]-pyridine iron(II) chloride of Example 3 with 26.1 mmol MAO (30% by weight in toluene, 4.75 M, Albermale) in 8 ml toluene was added drop wise and the mixture was stirred for 2 h. 20.3 g of an ivory-coloured powder were obtained.

### Example 5

### Solutions for Polymerizations

### IPRA-Solution

8.5 ml of a solution of IPRA in hexane (70% by weight, Crompton) were provided and filled up with heptane to 100 ml.

Costelan® AS 100-solution

0.55 ml Costelan® AS 100 (from Costenoble) were provided and filled up with heptane to 100 ml.

### Example 6

### Polymerization

At room temperature, 1 ml Costelan® AS 100-solution and 3 ml IPRA-solution were placed in a 1-1-autoclave, flushed with argon, and heated to 70° C. Then 400 ml isobutane were pressed by ethylene from a sample vessel into the autoclave and the pressure was raised by ethylene up to 40 bar. 82 mg of the catalyst prepared in Example 4 were added through a lance. The measure and control system was started, which automatically raised the pressure with hexene and ethylene up to 40 bar and kept this pressure constant. Hexene was evaporated and ethylene was continuously added. The polymerization was conducted at 70° C. and 40 bar for 1 h. Process conditions and properties of the polymer obtained are listed in tables 1 and 2, while the properties of the first polymer fraction thereof were the following: density of 0.970 g/cm³, no incorporation of hexene, weight average molar mass M_{w} of 51000 g/mol, polydispersity M_{w}/Mₙ of 6.8, tot. CH₃ 1/1000 C of 4.6, and vinyl 1/1000 C of 2.38.

### Example 7

### Polymerization

At room temperature, 80 g polyethylene sample were placed in a 1-l-autoclave, and heated to 70° C. Then 3 ml IPRA solution and 1 ml Costelan® AS 100-solution were injected at 70° C. 197 mg of the catalyst prepared in Example 4 were added under inert conditions and the pressure was raised by argon up to 10 bar. The measure and control system was started, which automatically raised the pressure with ethylene up to 20 bar and kept this pressure constant. The polymerization was conducted at 70° C. and 20 bar for 1 h. Process conditions and properties of the polymer obtained are listed in tables 1 and 2.

### Example 8

### Polymerization

At room temperature, 100 g polyethylene sample were placed in a 1-l-autoclave, flushed with argon, and then heated to 70° C. Then 4 ml IPRA-solution and 1 ml Costelan® AS 100-solution were injected at 70° C. 209 mg of the catalyst prepared in Example 4 were added under inert conditions and the pressure was raised by argon up to 10 bar. The measure and control system was started, which automatically raised the pressure with hexene and ethylene up to 20 bar and kept this pressure constant. The polymerization was conducted at 70° C. and 20 bar for 1 h. Process conditions and properties of the polymer obtained are listed in tables 1 and 2.

TABLE 1

| | Amount | Amount | Amount | | | | |
|---|---|---|---|---|---|---|---|
| | cat. | Ethene | C6 | Duration | Yield | Prod. | [η] |
| Example | [mg] | [l] | [ml] | [min] | [g] | [g/g] | [dl/g] |
| Ex. 6 | 82 | 5.7 | 10 | 60 | 30 | 366 | 10.84 |
| Ex. 7 | 197 | 79 | — | 60 | 88 | 447 | 3.05 |
| Ex. 8 | 209 | 94 | 12 | 60 | 101 | 483 | 2.40 |

TABLE 2

| | | | | | | trans | | |
|---|---|---|---|---|---|---|---|---|
| | | | | | tot. | double | vinyl double | |
| | M_{w} | Mₙ | | density | CH₃ | bonds | bonds | C6 |
| Example | [g/mol] | [g/mol] | M_{w}/Mₙ | [g/cm³] | [1/1000 C] | [1/1000 C] | [1/1000 C] | [%] |
| Ex. 6 | 737795 | 6348 | 116 | 0.960 | 3.0 | 0.03 | 2.17 | 0.8 |
| Ex. 7 | 234550 | 7205 | 32 | 0.967 | 3.5 | 0.02 | 2.28 | — |
| Ex. 8 | 148260 | 5899 | 25 | 0.965 | 4.0 | 0.05 | 2.52 | 0.8 |

Abbreviations in the tables above:
Cat. catalyst
prod. productivity of the catalyst in g of polymer obtained per g of catalyst used per hour
[η] intrinsic viscosity
M_{w} weight average molecular mass
Mₙ number average molecular mass
M_{w}/Mₙ polydispersity index=ratio of weight average molecular mass and number average molecular mass
density polymer density
tot CH₃/1000 C is to total CH₃/1000 carbon atoms (including end groups)
trans double bonds is the content of trans bonds/1000 carbon atoms as determined by means of IR, ASTM D 6248-98
vinyl double bonds is the content of vinyl groups/1000 carbon atoms as determined by means of IR, ASTM D 6248-98
C6 is the content of hexene comonomer

1-9. (canceled)

10. A catalyst composition comprising
(A) at least one chromium catalyst based on chromium oxide,
and
(B) at least one iron catalyst of formula (I), 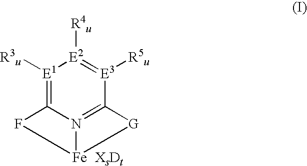
wherein the variables have the following meaning:
F and G, independently of one another, are selected from the group consisting of: 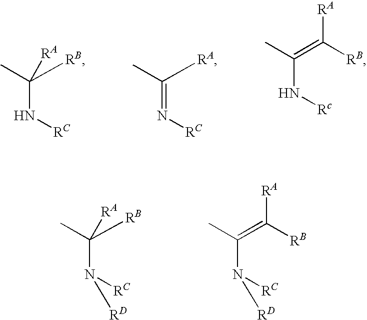
wherein
R^{A},R^{B} independently of one another denote hydrogen, C₁-C₂₀-alkyl, C₂-C₂₀-alkenyl, C₆-C₂₀-aryl, arylalkyl having 1 to 10 C atoms in the alkyl radical and 6 to 20 C atoms in the aryl radical, or SiR^{11A}₃, wherein the organic radicals R^{A},R^{B} can also be substituted by halogens, and in each case two radicals R^{A},R^{B} can also be bonded with one another to form a five- or six-membered ring,
R^{C},R^{D} independently of one another denote hydrogen, C₁-C₂₀-alkyl, C₂-C₂₀-alkenyl, C₆-C₂₀-aryl, arylalkyl having 1 to 10 C atoms in the alkyl radical and 6 to 20 C atoms in the aryl radical, or SiR^{11A}₃, wherein the organic radicals R^{C},R^{D} can also be substituted by halogens, and in each case two radicals R^{C},R^{D} can also be bonded with one another to form a five- or six-membered ring,
R^{11A} independently of one another denote hydrogen, C₁-C₂₂-alkyl, C₂-C₂₂-alkenyl, C₆-C₂₂-aryl, arylalkyl having 1 to 10 C atoms in the alkyl radical and 6 to 20 C atoms in the aryl radical, and two radicals R^{11A} can also be bonded with one another to form a five- or six-membered ring,
R³-R⁵ independently of one another denote hydrogen, C₁-C₂₂-alkyl, C₂-C₂₂-alkenyl, C₆-C₂₂-aryl, arylalkyl having 1 to 10 C atoms in the alkyl radical and 6-20 C atoms in the aryl radical, NR¹⁶₂, OR¹⁶, halogen, SiR¹⁷₃ or five-, six- or seven-membered heterocyclyl, which comprises at least one atom from the group consisting of N, P, O or S, wherein the organic radicals R³-R⁵ can also be substituted by halogens, NR¹⁶₂, OR¹⁶ or SiR¹⁷₃ and in each case two radicals R³-R⁵ can be bonded with one another to form a five-, six- or seven-membered ring or a five-, six- or seven-membered heterocyclyl, which comprises at least one atom from the group consisting of N, P, O or S,
R¹⁶ independently of one another denote hydrogen, C₁-C₂₂-alkyl, C₂-C₂₂-alkenyl, C₆-C₂₂-aryl, arylalkyl having 1 to 10 C atoms in the alkyl radical and 6-20 C atoms in the aryl radical or SiR¹⁷₃, wherein the organic radicals R¹⁶ can also be substituted by halogens and in each case two radicals R¹⁶ can also be bonded to form a five- or six-membered ring,
R¹⁷ independently of one another denote hydrogen, C₁-C₂₂-alkyl, C₂-C₂₂-alkenyl, C₆-C₂₂-aryl or arylalkyl having 1 to 10 C atoms in the alkyl radical and 6-20 C atoms in the aryl radical and in each case two radicals R¹⁷ can also be bonded to form a five- or six-membered ring,
E¹-E³ independently of one another denote carbon, nitrogen or phosphorus, and
u independently of one another is 0 for E¹-E³ as nitrogen or phosphorus and is 1 for E¹-E³ as carbon,
X independently of one another denote fluorine, chlorine, bromine, iodine, hydrogen, C₁-C₁₀-alkyl, C₂-C₁₀-alkenyl, C₆-C₂₀-aryl, arylalkyl having 1-10 C atoms in the alkyl radical and 6-20 C atoms in the aryl radical, wherein the organic radicals X can also be substituted by R¹⁸, NR¹⁸₂, OR¹⁸, SR¹⁸, SO₃R¹⁸, OC(O)R¹⁸, CN, SCN, β-diketonate, CO, BF₄⁻, PF₆⁻ or bulky non-coordinating anions and wherein the radicals X, if appropriate, are bonded with one another,
R¹⁸ independently of one another denote hydrogen, C₁-C₂₀-alkyl, C₂-C₂₀-alkenyl, C₆-C₂₀-aryl, arylalkyl having 1 to 10 C atoms in the alkyl radical and 6-20 C atoms in the aryl radical or SiR¹⁹₃, wherein the organic radicals R¹⁸ can also be substituted by halogens or nitrogen- and oxygen-containing groups and in each case two radicals R¹⁸ can also be bonded to form a five- or six-membered ring,
R¹⁹ independently of one another denote hydrogen, C₁-C₂₀-alkyl, C₂-C₂₀-alkenyl, C₆-C₂₀-aryl or arylalkyl having 1 to 10 C atoms in the alkyl radical and 6-20 C atoms in the aryl radical, wherein the organic radicals R¹⁹ can also be substituted by halogens or nitrogen- and oxygen-containing groups and in each case two radicals R¹⁹ can also be bonded to form a five- or six-membered ring,
s is 1, 2, 3 or 4,
D is a neutral donor and
t is 0 to 4.

11. The catalyst composition according to claim 10, further comprising:
(H) at least one organic or inorganic support,
(J) optionally at least one activating compound, and
(K) optionally at least one metal compound of a metal of group 1, 2 or 13 of the Periodic Table of Elements.

12. The catalyst composition according to claim 10, the catalyst composition being prepolymerized by polymerizing linear C₂-C₁₀-1-alkenes onto the catalyst composition in a mass ratio of from 1:0.1 to 1:200.

13. A process comprising polymerizing olefins or copolymerizing olefins with at least one alpha-olefin using the catalyst composition according to claim 10.

14. The process according to claim 13 wherein the resulting olefin polymer is a multimodal polyethylene comprising at least one first ethylene polymer fraction including a homopolymer having a first molecular weight, and at least one second ethylene polymer fraction including an ethylene copolymer having a second molecular weight higher than said first molecular weight, the multimodal polyethylene having a density of 0.915-0.970 g/cm³, a weight average molar mass M_{w} of 100 000-900 000 g/mol, and a polydispersity M_{w}/Mₙ of at least 15, wherein the at least one homopolymer has a density of 0.950-0.975 g/cm³, a weight average molar mass M_{w} of 10 000-90 000 g/mol, and a polydispersity M_{w}/Mₙ higher than 3 and lower than 10, and wherein the at least one copolymer has a polydispersity M_{w}/Mₙ between 8 and 80.

15. A multimodal polyethylene comprising at least one first ethylene polymer fraction including a homopolymer having a first molecular weight, and at least one second ethylene polymer fraction including an ethylene copolymer having a second molecular weight higher than said first molecular weight, the multimodal polyethylene having a density of 0.915-0.970 g/cm³, a weight average molar mass M_{w} of 100 000-900 000 g/mol, and a polydispersity M_{w}/Mₙ of at least 15, wherein the at least one homopolymer has a density of 0.950-0.975 g/cm³, a weight average molar mass M_{w} of 10 000-90 000 g/mol, and a polydispersity M_{w}/Mₙ higher than 3 and lower than 10, and wherein the at least one copolymer has a polydispersity M_{w}/Mₙ between 8 and 80.

16. The multimodal polyethylene according to claim 15, comprising at least 1.5 vinyl groups/1000 carbon atoms.

17. A process comprising injection moulding, blow moulding, or extrusion moulding the multimodal polyethylene according to claim 15.
